(19) United States
(12) Patent Application Publication
(10) Pub. No.: US 2023/0281359 A1
(43) Pub. Date: Sep. 7, 2023

(54) High Speed Emulation in a Vehicle-in-the-Loop Driving Simulator

(71) Applicant: The Board of Trustees of the Leland Stanford Junior University, Stanford, CA (US)

(72) Inventors: Elliot Weiss, Palo Alto, CA (US); Joseph Christian Gardens, Los Altos, CA (US)

(21) Appl. No.: 18/118,064

(22) Filed: Mar. 6, 2023

Related U.S. Application Data
(60) Provisional application No. 63/317,045, filed on Mar. 6, 2022.

(51) Int. Cl. G06F 30/20

(52) U.S. Cl. CPC G06F 30/20; G06F 2111/18

(57) ABSTRACT

High-speed emulation in a vehicle-in-the-loop driving simulator is provided.

### CROSS-REFERENCE TO RELATED APPLICATIONS

This application claims priority from U.S. Provisional Patent Application 63/317,045 filed Mar. 6, 2022, which is incorporated herein by reference.

### FIELD OF THE INVENTION

This invention relates to driving simulators.

### BACKGROUND OF THE INVENTION

Rendering accurate multisensory feedback is critical to ensure natural user behavior in driving simulators. The present invention addresses these topics.

### SUMMARY OF THE INVENTION

In this invention, a virtual reality (VR)-based Vehicle-in-the-Loop (ViL) simulator is presented that provides visual, vestibular, and haptic feedback to drivers in high-speed driving conditions. Designing our simulator around a four-wheel steer-by-wire vehicle enables us to emulate the dynamics of a vehicle traveling significantly faster than the test vehicle and to transmit corresponding haptic steering feedback to the driver. By scaling the speed of the test vehicle through a combination of VR visuals, vehicle dynamics emulation, and steering wheel force feedback, one can safely and immersively run experiments up to highway speeds within a limited driving space. In double lane change and highway weaving experiments, the high-speed emulation method tracks yaw motion within human perception limits and provides sensory feedback comparable to the same tests driven manually.

### DETAILED DESCRIPTION

Other embodiments, further teachings and/or examples related to the invention are described in U.S. Provisional Patent Application 63/317,045 filed Mar. 6, 2022, which is incorporated herein by reference in its entirety.

What is claimed is:

1. A driving simulator system to emulate high-speeds, comprising:
(a) a reference dynamics model receiving control inputs from a driver, wherein the reference dynamics model computes a vehicle state; and
(b) multi-sensory feedback system providing feedback to the driver, wherein the reference dynamics model contributes to the rendering of the feedback.
